(19) United States
(12) Patent Application Publication
(10) Pub. No.: US 2020/0360225 A1
(43) Pub. Date: Nov. 19, 2020

(54) CUFF FOR RECEIVING AT LEAST PART OF AN OUTER EXTREMITY OF A PERSON

(71) Applicant: REACTIVE ROBOTICS GMBH, MUENCHEN (DE)

(72) Inventors: ALEXANDER KOENIG, MUENCHEN (DE); RAMONA SUSANNA SCHLAEFER, MUENCHEN (DE); MANFRED KOESTLMEIER, PUTZBRUNN (DE)

(21) Appl. No.: 16/966,549

(22) PCT Filed: Jan. 28, 2019
(86) PCT No.: PCT/DE2019/100088

§ 371 Date: Jul. 31, 2020

(30) Foreign Application Priority Data
Jan. 31, 2018 (DE) 10 2018 102 107.0

(51) Int. Cl. A61H 9/00

(52) U.S. Cl. CPC A61H 9/0092; A61H 2201/0192; A61H 2201/1409; A61H 2201/1654; A61H 2201/169; A61H 2201/165

(57) ABSTRACT

A cuff for receiving at least part of an outer extremity of a person contains an inner structure, which is provided to bear on the outer extremity of the person, and an outer structure, which supports the inner structure. The inner structure contains a cavity filled with a fluid which, within the cavity, distributes itself at least in part across the cuff surface spanned by the longer sides and shorter sides of the inner structure of the cuff. It makes available a receiving device which is an improvement which permits optimized transmission of force from a machine, in particular a rehabilitation mechanism or training apparatus, to a person. Since it is formed without seams, it is particularly suitable for use in an environment in which strict demands are placed on cleaning possibilities and hygiene.

The present invention relates to a cuff for receiving at least part of an outer extremity of a person.

The development of new machine-assisted training and rehabilitation devices and methods advances year by year. Rehabilitation mechanisms, for example of the kind known from WO 2017/063639 A1, can advantageously permit regular and cost-effective mobilization of bedridden patients at the earliest possible opportunity, which can have a lasting and positive effect on the convalescence of the patients. In addition, a large number of training appliances are known in particular for running exercises, for example of the kind known from DE 10 2011 107 382 A1, which appliances interact with the runner and in so doing are able to increase his or her physical performance, but are advantageously gentle on the muscle and tendon apparatus.

For the interaction between such rehabilitation mechanisms or training appliances and the human being, receiving devices in the form of harnesses, straps and/or cuffs are always necessary.

Depending on the specific field of use, these receiving devices have to meet very different technical requirements. Whereas training appliances for running exercises performed by healthy runners are required to permit a controlled transmission and distribution of force from the device to the human and also in particular to be comfortable to wear, receiving devices used in the context of the rehabilitation of intensive care patients in some cases also have to satisfy very different and often more complex requirements, especially as regards hygiene and/or the ease with which they can be fitted in place and removed by the user or by a third party.

Bedridden persons, in particular intensive care patients, are often almost completely limited in terms of their freedom of movement, on account of their muscle weakness, possible unconsciousness and/or the fact that they are connected to diagnostic equipment, catheters and the like. If such a patient is to be mobilized with machine assistance, the human-machine connection requires the provision of receiving devices which are easy to put on and take off, permit optimal performance of the desired movement exercises and at the same time do not interfere with the often life-maintaining equipment connections to diagnostic and therapeutic appliances. In addition, receiving devices in this field need to meet strict requirements in respect of cleaning possibilities, so as to be able at all times to ensure perfect hygienic conditions for the patient.

DE 33 35 251 A1 has disclosed a thigh cuff which is made of thermoplastic material for orthopedic purposes and which, on account of its special shape and its special closure mechanism, advantageously adapts to the user's thigh and thereby advantageously avoids blood stasis and the formation of pressure sores. However, a connection to rehabilitation mechanisms and/or training appliances is not provided here.

The object of the present invention is therefore to make available a receiving device which is improved over the prior art and which serves to receive at least part of an outer extremity of a person and, within a hygienic environment, permits optimized transmission of force from a machine, in particular a rehabilitation mechanism or training appliance, to a person, can be easily fitted on the person and taken off, in particular by third parties, and does not interfere with any further equipment connections between the person and other diagnostic and therapeutic devices.

This object is achieved by a cuff, for receiving at least part of an outer extremity of a person, having the features of independent claim 1.

A cuff according to the invention proceeds from a cuff comprising:
an inner structure, which is provided to bear on the outer extremity of a person and which is delimited by two mutually opposite shorter sides and two mutually opposite longer sides;
and an outer structure, which supports the inner structure and which is delimited by two mutually opposite shorter sides and two mutually opposite longer sides;
wherein at least one first and one second fastening means for fastening a carrier means of a load relief system are arranged on the outer structure;
and wherein the cuff has at least one closure permitting a width adjustment and comprising a first closure part and a second closure part, for reversibly fastening the two shorter sides of the outer structure or the two shorter sides of the inner structure to each other,
and wherein the inner structure of the cuff according to the invention comprises a cavity filled with a fluid which, within the cavity, distributes itself at least in part across the cuff surface spanned by the longer sides and shorter sides of the inner structure of the cuff.

A cuff according to the invention advantageously allows outer extremities, in particular a thigh of a person, to be received safely, comfortably and without injury. By way of the fluid-filled inner structure of the cuff, pressure and force effects of the cuff are distributed to the outer extremities, in particular to the person's thigh, in an advantageously uniform manner over the entire bearing surface of the cuff. This increases the wearing comfort and avoids pressure sores or localized (over)straining and injuries of the extremities. The closure permitting a width adjustment, and comprising a first closure part and a second closure part for reversibly fastening the two shorter sides of the outer structure or the two shorter sides of the inner structure to each other, advantageously allows the cuff to be easily fitted in place and taken off by the person himself or by a third party, for example a physiotherapist or the nursing staff.

Further advantageous embodiments and developments, which can be used individually or in combination with one another, are the subject matter of the dependent claims.

In a preferred embodiment of the invention, the inner structure, in particular the cavity thereof, can be divided into at least two interconnected segments, in such a way that the fluid can distribute itself between the segments. The segments can be formed, for example, by a process in which the two mutually opposite cuff surfaces of the inner structure are connected to each other at selected points, preferably by welding and/or adhesive bonding, and thereby form so-called webs. The connection of the segments to one another then advantageously ensures the filling and/or uniform distribution of the entire cavity with the fluid.

In a further embodiment, it has proven particularly expedient that the inner structure, in particular the cavity thereof, is divided into a multiplicity of interconnected segments, preferably between 10 and 20 thereof, in such a way that the fluid can distribute itself between the segments, wherein the segments are oriented in terms of their length substantially along the longer sides, substantially along the shorter sides, or in part substantially along the longer sides and in part substantially along the shorter sides. A segmentation of the cavity advantageously prevents a situation where the fluid, especially during a change of position (during movement) of the cuff, moves (too) quickly to one side of the cuff (according to gravity). The distribution of force from the cuff to the extremity of the person thus advantageously remains constant. In addition, the segmentation prevents a situation where the two mutually opposite cuff surfaces spanned by the shorter and longer sides shift with respect to each other, and it thus ensures improved stability and improved frictional connection to the extremity. The segmentation can be provided to different extents. The webs formed by the connections between mutually opposite cuff surfaces of the inner structure can be arranged in the direction of the shorter or longer side or both. A lengthwise arrangement (along the longer side), especially in the edge region, simplifies the fitting of the cuff, since the ends of the cuff slide more easily over each other at the overlap site. If the webs are oriented in the other direction, this makes fitting the cuff difficult, since there is a slight blocking of the short side by the webs.

In a preferred embodiment, the fluid can be a gel-like substance, in particular a mixture of sodium polyacrylate and water. The normally higher viscosity of a gel compared to a liquid, for example water, advantageously also ensures that, when the position of the cuff changes during a movement of the person, a uniform distribution of the fluid takes place over the entire inner structure, in particular the cavity thereof. If the inner structure is damaged, a gel also advantageously remains longer inside the cavity and permits renewed sealing of the inner structure, without contaminating the environment too much by escape of the fluid.

In addition, an embodiment of the invention has proven expedient in which the outer structure comprises at least one support element which flexibly supports the cuff along the longer sides and/or the shorter sides. The at least one flexible support element supports the cuff, in particular the cuff surface, advantageously from one shorter side to the opposite shorter side and/or from one longer side to the opposite longer side, thereby ensuring an improved and in particular uniform transmission of force to the extremities, wherein the flexibility of the cuff remains ensured, particularly in the context of the bending the two shorter mutually opposite sides.

It may be preferable if the at least one outer structure comprises at least one outer cover layer and at least one inner cover layer, which envelop the support element on the outside and inside, respectively. The outer cover layer advantageously protects the support means and the inner structure against contamination, whereas the inner cover layer protects the inner structure in particular against an action of the support means, in this way avoiding penetration of the support element into the cavity and advantageously preventing leakage of the fluid.

It has also proven expedient if the support element is formed from a spring steel and/or from a glass-fiber-reinforced plastic. Both classes of material are easy to process and advantageously serve as cost-effective and at the same time robust starting materials for the production of a support element.

In a preferred embodiment of the invention, the support element can extend at least across part of the cuff surface and/or can comprise cutouts for increasing the flexibility of the support element. By means of a support element extending at least across part of the cuff surface, the inner structure in particular is advantageously supported. Any cutouts that are present advantageously increase the flexibility of the support element while maintaining the support effect.

In an alternative embodiment, the outer structure can also have a multiplicity of support elements in the form of individual lamellas which in terms of their length are oriented substantially along the shorter sides of the outer structure. Individual lamellas have the advantage that, in the event of a complete collapse of the cuff, breaking or bending of the support means is avoided.

According to the invention, an embodiment is also preferred in which the at least one outer structure and the at least one inner structure are connected to each other seamlessly. A seamless connection of the two structures, preferably by weld seams or by flush adhesive bonding, advantageously avoids contamination in any space present between the inner and outer structure and makes cleaning and/or disinfecting of the cuff easier and more time efficient.

In a further preferred embodiment, a filling valve for filling the inner structure, in particular the cavity thereof, can be provided on the outer structure and/or on the inner structure. A filling valve advantageously affords a filling possibility and/or refilling possibility for the fluid. It is preferably arranged on the outer structure since, in this way, direct contact with the person and therefore the risk of injury to the person can advantageously be further minimized.

It is additionally preferred if the cuff, in particular the inner structure thereof, is formed at least in part from plastic, wherein the plastic is biocompatible, preferably a thermoplastic polyurethane. Alternatively or in addition, the cuff, in particular the inner structure thereof, can also be provided with a sheath made of a biocompatible plastic. The use of a biocompatible plastic for the production of the cuff or the provision of a sheath made of biocompatible plastic advantageously permits direct contact with the skin. Particularly in the case of intensive care patients, who do not normally wear pants, just hospital nightgowns that can be quickly changed, this can make it easier to apply the cuff and yet still permit comfortable use for the patient. The use of plastic additionally simplifies the cleaning of the cuff and thus advantageously permits time-efficient disinfection.

In a preferred embodiment according to the invention, at least one first and one second fastening means for fastening a carrier means of a load relief system can additionally be arranged on the outer structure. With the aid of these fastening means, the cuff can be advantageously connected to a load relief system, in particular a bodyweight relief system of a rehabilitation mechanism.

It has proven expedient, in a preferred embodiment, that the fastening means are displaceable along the longer sides and/or the shorter sides of the outer structure. If the fastening means are displaceable, the fastening means can be arranged on the cuff, depending on the diameter of the person's thigh, such that a uniform tensile force is exerted on the cuff via the fastening means.

Moreover, an embodiment of the invention is preferred in which all components rigidly connected to the outer structure, in particular the filling valve, the first closure part and second closure part, and the fastening means, are connected to the outer structure, in particular to the outer cover layer thereof, via seamless connections. A seamless connection of all the components rigidly connected to the outer structure, preferably by weld seams or by flush adhesive bonding, advantageously permits the construction of a cuff having the smoothest possible surface, which is largely free of material pockets, overlaps or other irregularities that would be difficult to access during cleaning and/or disinfecting. By contrast, a “seamless” cuff of this kind can be quickly and effectively cleaned after each use by simply wiping it with a disinfectant.

Finally, a cuff connected to carrier means of a load relief system is preferably characterized in that it is configured for positive and non-positive transmission of longitudinal forces L and/or transverse forces Q to the outer extremity of a person, in particular to the thigh of the person. It is thus advantageously possible to ensure that pressure and force effects are transmitted from the load relief system, or the carrier means thereof, to the outer extremity of a person as uniformly as possible over the entire bearing surface of the cuff.

The present invention makes available a receiving device in the form of a cuff which is improved over the prior art and which serves to receive at least part of an outer extremity of a person and, within a hygienic environment, permits optimized transmission of force from a machine, in particular a rehabilitation mechanism or training appliance, to a person. Particularly since it is formed without seams, it is especially suitable for use in an environment in which strict demands are placed on cleaning possibilities and hygiene, for example in the rehabilitation of intensive care patients in an intensive care unit. The cuff according to the invention can be easily fitted on a person and removed again, in particular by a third party, and it can be advantageously adapted to different body sizes by virtue of its closure technique and a possible overlapping of the ends of the cuff in what is called a “one size fits all” solution. Finally, on account of its being able to be positioned on outer extremities, in particular on the thigh of a person, it advantageously prevents any interference with further equipment connections set up between the person and other diagnostic and therapeutic devices.

Additional details and further advantages of the invention are described below on the basis of preferred illustrative embodiments, to which the present invention is not limited however, and in conjunction with the accompanying schematic drawing, in which:

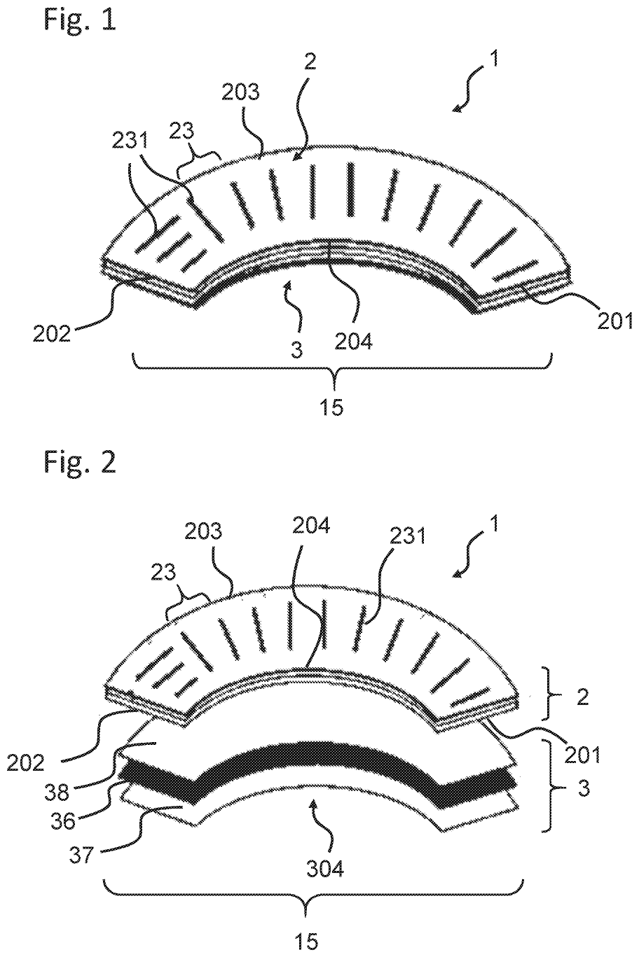

FIG. 1 shows an embodiment of a cuff according to the invention, with a view of an inner structure;

FIG. 2 shows a view of the layered configuration of the cuff, from the viewing angle of FIG. 1;

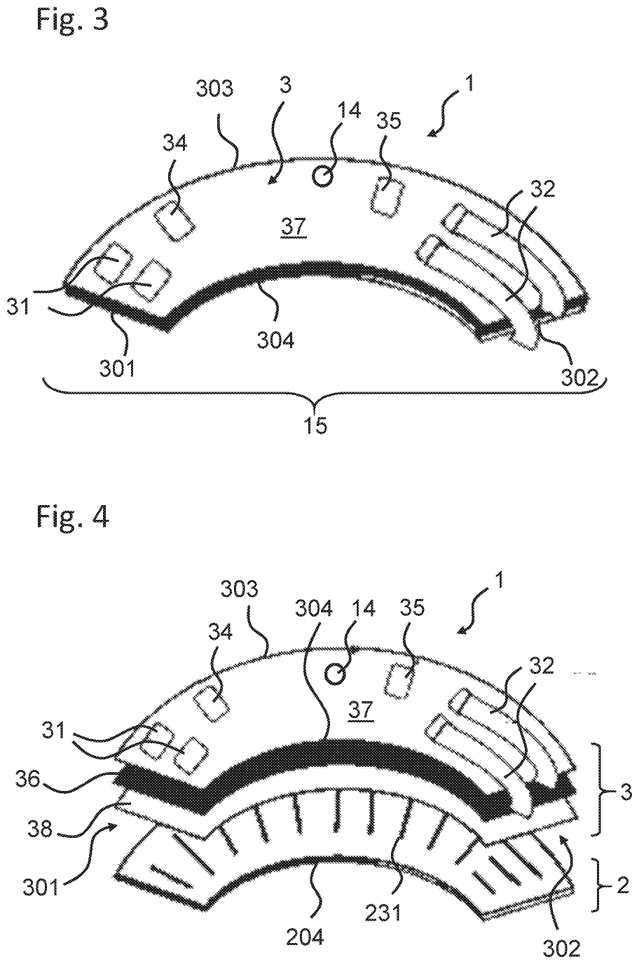

FIG. 3 shows the cuff from FIG. 1 with a view of an outer structure;

FIG. 4 shows a view of the layered configuration of the cuff, from the viewing angle of FIG. 3;

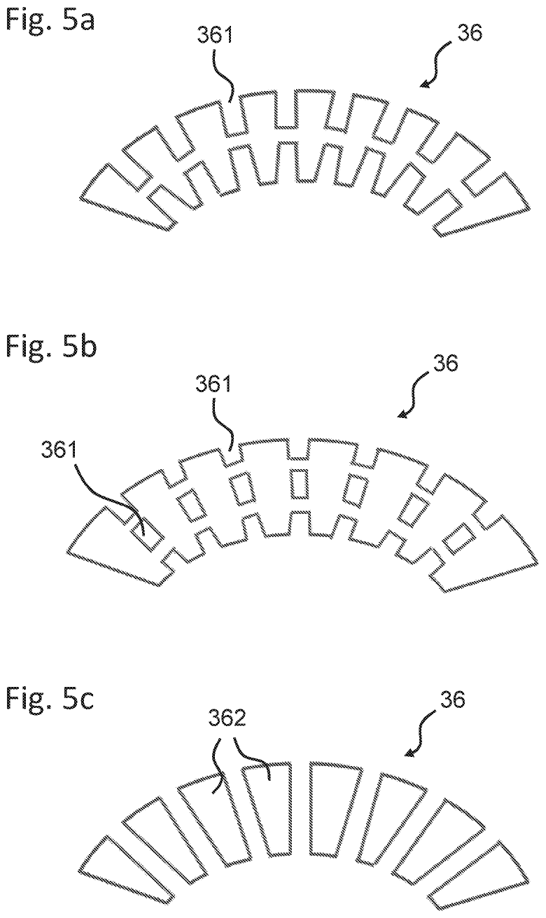

FIG. 5a shows a first embodiment of a support element of the outer structure;

FIG. 5b shows a second embodiment of a support element;

FIG. 5c shows a third embodiment of a support element;

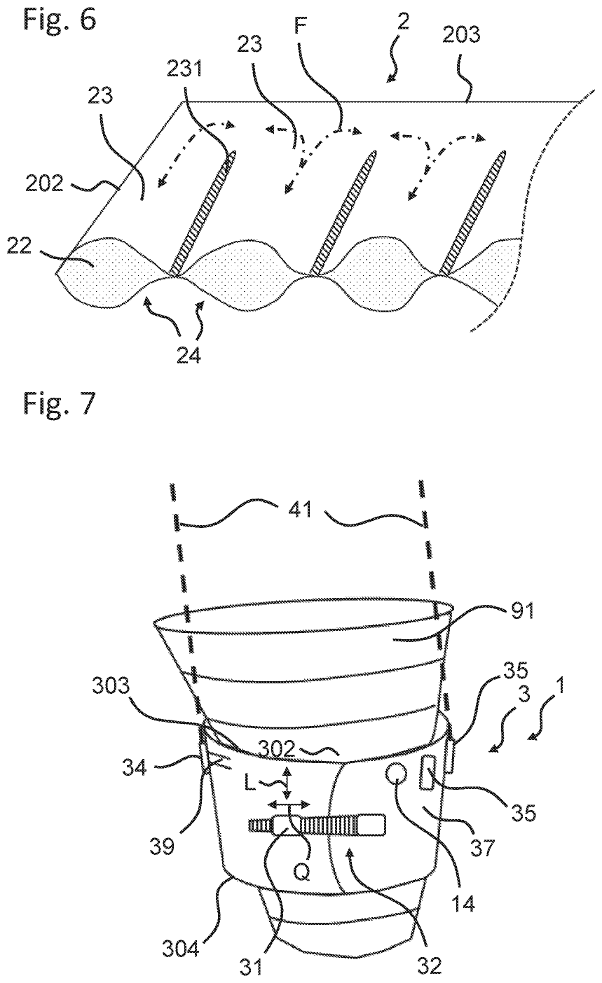

FIG. 6 shows a vertical section through the inner structure, along the longer sides; and

FIG. 7 shows an embodiment of a cuff during use by a person, with fastening means for fastening a carrier means of a load relief system.

In the following description of preferred embodiments of the present invention, identical reference signs designate identical or comparable components.

FIG. 1 shows an embodiment of a cuff 1 according to the invention, with a view of an inner structure 2. The inner structure 2, provided to bear on the outer extremity of a person, is delimited by two mutually opposite shorter sides 201; 202 and two mutually opposite longer sides 203 and 204. An outer structure 3, which supports the inner structure 2 and for its part is delimited by two mutually opposite shorter sides 301 and 302 and two mutually opposite longer sides 303 and 304, is concealed in FIG. 1 by the inner structure 2 (cf. FIGS. 3 and 4).

The longer sides 203 and 204 or 303 and 304 can be of the same length or, as shown here, of unequal length, in which case the shorter sides 204, 304, during use by a person, preferably become “lower sides”, and the longer sides 203, 303 then preferably become “upper sides” with respect to the extremity that is received. The embodiment shown here, with unequal lengths of the sides 203 and 204 or 303 and 304, can advantageously lead in the state of use to a conical shape (cf. FIG. 7) which, in accordance with the shape of the extremity received, tapers at one side with respect to the diameter of the cuff 1 applied to the extremity.

If the longer sides 203 and 204 or 303 and 304 are of equal length (not shown here), a corresponding adaptation to the shape of the extremity can preferably be achieved if the inner structure 2 in the region of the longer, “lower” side 204 has a larger volume than in the region of the longer “upper” side 203. In this way, with equal lengths of the sides 203 and 204 or 303 and 304, it is likewise possible to generate a conical shape, in particular of the inner structure 2, adapted to the shape of the extremity of the person.

According to the invention, the inner structure 2 comprises a cavity 24 filled with a fluid 22 which, within the cavity 24, distributes itself at least in part across the cuff surface 15 spanned by the longer sides 203 and 204 and shorter sides 201 and 202 of the inner structure 2 of the cuff 1. FIG. 6 shows a vertical section through the inner structure 2, along the longer sides 203 and 204, where the cavity 24 filled with fluid 22 can be seen.

The inner structure 2, in particular the cavity 24 thereof, can preferably be divided into at least two interconnected segments 23, in such a way that the fluid 22 can distribute itself between these segments 23. An embodiment of the invention is particularly preferred in which the inner structure 2, in particular the cavity 24 thereof, is divided, as shown here, into a multiplicity of interconnected segments 23, preferably between 10 and 20 thereof, in such a way that the fluid 22 can distribute itself between the segments 23. The segments 23 can be oriented in terms of their length substantially along the longer sides 203 and 204, substantially along the shorter sides 201 and 202, or in part substantially along the longer sides 203 and 204 and in part substantially along the shorter sides 201 and 202, as can be seen in FIGS. 1 and 2 in the context of an exemplary arrangement. The size of the individual segments 23 can be the same or different, and it can be advantageous for the size of the segments 23 to the shorter sides 201 and 202 to be chosen smaller than in the middle region of the cuff surface 15, in order to permit a better overlap of the cuff 1 in the region of the shorter sides 201 and 202.

FIG. 2 shows an illustration of the layered configuration of the cuff 1, from the viewing angle of FIG. 1. Below the inner structure 2, an embodiment of the outer structure 3, which supports the inner structure 2, can be seen in a kind of exploded view.

FIG. 3 shows the cuff 1 from FIG. 1, with a view of an outer structure 3, and FIG. 4 in turn shows a kind of exploded view corresponding to the viewing direction from FIG. 3.

The cuff 1 can advantageously have at least one closure permitting a width adjustment and comprising a first closure part 31 and a second closure part 32 or, as shown here, two first closure parts 31 and two second closure parts 32, for reversibly fastening the two shorter sides 301 and 302 of the outer structure 3 or the two shorter sides 201 and 202 of the inner structure 2 to each other. By overlapping the first, shorter sides 201, 301 with the second, shorter sides 202, 302, the cuff 1 can advantageously be adapted to the circumference of the extremity, in particular to the thigh 91 of the person. The cuff 1 according to the invention can thus advantageously provide what is called a “one size fits all” solution.

Moreover, the closure can be designed in particular as a Fidlock closure, i.e. as a magnetic, self-centering snap buckle with acoustic feedback, which can advantageously increase the ease of use of the cuff 1. The second closure part 32 can also be formed advantageously as a plastic band, in particular made of a thermoplastic. It has proven particularly useful here if the second closure part or parts 32 have corrugations, in particular a corrugated surface, since in this way the interaction with the first closure part or parts 31 can be heightened by increasing the friction (cf. also FIG. 7).

As can be seen in FIG. 4, the outer structure 3 can advantageously comprise at least one support element 36, which flexibly supports the cuff 1 along the longer sides 303 and 304 and/or the shorter sides 301 and 302. The at least one outer structure 3 can also advantageously have a layered configuration and comprise at least one outer cover layer 37 and at least one inner cover layer 38, which envelop the support element 36 to the outside or inside.

A filling valve 14 for filling the inner structure 2, in particular the cavity 24 thereof, can be provided, as shown here, on the outer structure 3 of the cuff 1. Alternatively or in addition, the inner structure 2 can also comprise a filling valve 14 for filling the inner structure 2, in particular the cavity 24 thereof. FIG. 4 additionally shows that at least one first 34 and one second 35 fastening means for fastening a carrier means 41 of a load relief system 4 can advantageously be arranged on the outer structure. These fastening means 34 and 35 can be firmly fixed to the outer structure 3, in particular to the outer cover layer 37 of the latter, and/or can be arranged displaceably (not shown) along the longer sides 303 and 304 and/or the shorter sides 301 and 302 of the outer structure 3.

FIGS. 5a, 5b and 5c show three illustrative embodiments of the support element 36 of the outer structure 3 of the cuff 1. The support element 36 can preferably be formed from a spring steel and/or formed from a glass-fiber-reinforced plastic. As is shown in FIGS. 5a and 5b, the support element 36 can extend over at least part of the cuff surface 15 and/or can comprise cutouts 361 for increasing the flexibility of the support element 36. Alternatively or in addition, the outer structure 3 can also have a multiplicity of support elements 36 in the form of individual lamellas 362 which in terms of their length can be oriented substantially along the shorter sides 301 and 302 of the outer structure 3 (cf. FIG. 5c).

FIG. 6, as has already been mentioned above, shows a vertical section through the inner structure 2 along the longer sides 203 and 204. It can be seen that the inner structure 2 according to the invention comprises a cavity 24 filled with a fluid 22 which, within the cavity 24, can distribute itself at least in part across the cuff surface 15 spanned by the longer sides 203 and 204 and shorter sides 201 and 202 of the inner structure 2 of the cuff 1. An example of the possibility of distribution of the fluid 22 within the cavity 24 is indicated in FIG. 6 by dot-and-dash arrows, which correspond to possible flow directions F. In the example shown, the cavity 24 is divided into at least four segments 23 extending along the shorter sides 201 and 202. The segments 23 can be formed by two mutually opposite cuff surfaces 15 being welded and/or adhesively bonded to each other at least in parts, as a result of which webs 361 can be formed that at least partially separate the individual regions of the cavity from one another. It will also be seen in FIG. 6 that these segments 23 are preferably connected to one another, such that the fluid 22 can distribute itself at least in sections over the cuff surface 15 spanned by the longer sides 203 and 204 and shorter sides 201 and 202 of the inner structure 2 of the cuff 1. Here, for example, the webs 361 do not extend over the entire width of the cuff surface 15 and therefore, in the regions near the longer sides 203 and 204, they permit a connection of the individual segments 23. The fluid 22 can preferably be a gel-like substance, in particular a mixture of sodium polyacrylate and water. FIG. 7, finally, shows an embodiment of a cuff 1 during use by a person, with fastening means 34 and 35 for fastening a carrier means 41 of a load relief system (not shown here). It can be seen how a thigh 91 of a person is received by a cuff 1. Here, a first fastening means 34 and two second fastening means 35 for fastening a carrier means 41 of a load relief system are arranged on the outer structure 3. The first fastening means 34 is arranged here, by way of example, on a rail 39 and is thus displaceable along the longer sides 303 and 304 and/or the shorter sides 301 and 302 of the outer structure 3. By displaceability of the fastening means 35 and 35 and/or by arrangement of fastening means 34 and 35 at different positions on the outer structure 3, the points of engagement of the one or more carrier means 41 of the load relief system can be optimally chosen preferably depending on the diameter of the thigh 91 of the person.

A cuff connected, as shown in FIG. 7, to carrier means 41 of a load relief system is preferably characterized by being designed for positive and non-positive transmission of longitudinal forces L and/or transverse forces Q (indicated by way of example in FIG. 7 by double arrows) to the outer extremity of a person, in particular to the thigh 91 of the person. It is thus advantageously possible to ensure that pressure and force effects are transmitted from the load relief system, or the carrier means 41 thereof, to the outer extremity of a person as uniformly as possible via the entire bearing surface of the cuff 1.

Use in the medical field in particular imposes strict requirements in terms of the cleaning and disinfection of cuffs of this type. According to the invention, it is therefore preferable that the at least one outer structure 3 and the at least one inner structure 2 are connected to each other seamlessly. In addition, it may be advantageous if the cuff 1 and in particular the inner structure 2 thereof are formed at least partially from plastic, said plastic being biocompatible, preferably a thermoplastic polyurethane, as shown here. Alternatively or in addition, the cuff 1, in particular the inner structure 2 thereof, can also be provided with a sheath made of a biocompatible plastic. According to the invention, it is particularly preferable that all of the components rigidly connected to the outer structure 3, in particular the filling valve 14, the first closure part 31 and second closure part 32, and also the fastening means 34 and 35, are connected by seamless connections to the outer structure 3, in particular to the outer cover layer 37 of the latter.

The present invention relates to a cuff 1 for receiving at least part of an outer extremity of a person, wherein the cuff 1 comprises an inner structure 2, which is provided to bear on the outer extremity of the person, and an outer structure 3, which supports the inner structure 2. The inner structure 2 comprises a cavity 24 filled with a fluid 22 which, within the cavity 24, distributes itself at least in part across the cuff surface 15 spanned by the longer sides 203 and 204 and shorter sides 201 and 202 of the inner structure 2 of the cuff 1. It makes available a receiving device which is improved over the prior art and which permits optimized transmission of force from a machine, in particular a rehabilitation mechanism or training apparatus, to a person. Since it is formed without seams, it is especially suitable for use in an environment in which strict demands are placed on cleaning possibilities and hygiene.

### LIST OF REFERENCE SIGNS

1 cuff
14 filling valve
15 cuff surface
2 inner structure
201 first shorter side
202 second shorter side
203 first longer side
204 second longer side
22 fluid
23 segment
231 web
24 cavity
3 outer structure
301 first shorter side
302 second shorter side
303 first longer side
304 second longer side
31 first closure part
32 second closure part
34 first fastening means
35 second fastening means
36 support element
361 cutout
362 lamella
37 outer cover layer
38 inner cover layer
39 rail for fastening means 34 and 35
41 carrier means
91 thigh
F direction of flow of the fluid 22
L longitudinal forces
Q transverse forces

1-15. (canceled)

16. A cuff for receiving at least part of an outer extremity of a person, the cuff comprising:
an inner structure provided to bear on the outer extremity of the person and being delimited by two mutually opposite shorter sides and two mutually opposite longer sides;
an outer structure supporting said inner structure and being delimited by two mutually opposite shorter sides and two mutually opposite longer sides;
at least one first and one second fastener disposed on said outer structure for fastening to a carrier means of a load relief system;
at least one closure system permitting a width adjustment and having a first closure part and a second closure part, for reversibly fastening said two shorter sides of said outer structure or said two shorter sides of said inner structure to each other; and
said inner structure having a cavity formed therein and filled with a fluid, the fluid within said cavity distributes itself at least in part across a cuff surface spanned by said longer sides and said shorter sides of said inner structure.

17. The cuff according to claim 16, wherein said inner structure is divided into at least two interconnected segments, such that the fluid can distribute itself between said interconnected segments.

18. The cuff according to claim 16, wherein said inner structure, is divided into a plurality of interconnected segments such that the fluid can distribute itself between said interconnected segments, said interconnected segments are oriented in terms of their length substantially along said longer sides, substantially along said shorter sides, or in part substantially along said longer sides and in part substantially along said shorter sides.

19. The cuff according to claim 16, wherein the fluid is a gel-like substance.

20. The cuff according to claim 16, wherein said outer structure contains at least one support element which flexibly supports the cuff along said longer sides and/or said shorter sides.

21. The cuff according to claim 20, wherein said outer structure contains at least one outer cover layer and at least one inner cover layer, which envelop said support element on an outside and inside, respectively.

22. The cuff according to claim 20, wherein said support element is formed from a spring steel and/or from a glass-fiber-reinforced plastic.

23. The cuff according to claim 20, wherein said support element extends at least across part of the cuff surface and/or has cutouts formed therein for increasing a flexibility of said support element.

24. The cuff according to claim 20, wherein said outer structure has a plurality of support elements in a form of individual lamellas which in terms of their length are oriented substantially along said shorter sides of said outer structure.

25. The cuff according to claim 20, wherein said outer structure and said inner structure are connected to each other seamlessly.

26. The cuff according to claim 16, further comprising a filling valve disposed on at least one of said outer structure or on said inner structure for filling said inner structure.

27. The cuff according to claim 16,
wherein the cuff is formed at least in part from plastic; and/or
further comprising a sheath made of a biocompatible plastic.

28. The cuff according to claim 16, wherein said first and second fasteners are displaceable along said longer sides and/or said shorter sides of said outer structure.

29. The cuff according to claim 16, wherein all components rigidly connected to said outer structure are connected to said outer structure via seamless connections.

30. The cuff according to claim 16, wherein:
the cuff is configured to connect to the carrier means of the load relief system; and
the cuff is configured for form-locking and force-locking transmission of longitudinal forces and/or transverse forces to the outer extremity of the person.

31. The cuff according to claim 16, wherein said cavity of said inner structure is divided into at least two interconnected segments, such that the fluid can distribute itself between said interconnected segments.

32. The cuff according to claim 16, wherein the fluid is a mixture of sodium polyacrylate and water.

33. The cuff according to claim 16,
wherein said inner structure is formed at least in part from plastic, said plastic is biocompatible, preferably said plastic is a thermoplastic polyurethane; and/or
wherein said inner structure has a sheath made of a biocompatible plastic.

34. The cuff according to claim 26, wherein said filling valve, said first closure part, said second closure part, and said first and second fasteners are connected to said outer cover layer of said outer structure via seamless connections.

35. The cuff according to claim 30, wherein the cuff is configured for a form-locking and force-locking transmission of the longitudinal forces and/or the transverse forces to a thigh of the person.
